(19) United States
(12) Patent Application Publication
(10) Pub. No.: US 2023/0402225 A1
(43) Pub. Date: Dec. 14, 2023

(54) TRANSFORMER OF ENHANCE COMMON-MODE REJECTION RATIO

(71) Applicant: TAI-TECH ADVANCED ELECTRONICS CO., LTD., Taoyuan City (TW)

(72) Inventors: Ming-Yen Hsieh, Taoyuan City (TW); Pao Lin Shen, Taoyuan City (TW); Hsiang Chung Yang, Taoyuan City (TW)

(21) Appl. No.: 17/839,445

(22) Filed: Jun. 13, 2022

(51) Int. Cl. H01F 27/33; H01F 27/24; H01F 27/28

(52) U.S. Cl. CPC H01F 27/33; H01F 27/24; H01F 27/28

(57) ABSTRACT

The transformer includes iron core and coils. The iron core includes a first flange, a second flange, and a central column having a first face and a second face. The coils include a first coil and a second coil wound around the central column from the first flange towards the second flange. Within a first layer of coils along the first face, there are sequentially arranged at least a first coil, a first coil, a second coil, a first coil, a second coil, a gap, a second coil, a first coil, and multiple rounds of first coil. Within the first layer along the second face, there are sequentially arranged multiple rounds of the first coil, a first coil, a second coil, a gap, a second coil, a first coil, and multiple rounds of the first coil. Within a second layer there are multiple rounds of the second coil.

### BACKGROUND OF THE INVENTION

### (a) Technical Field of the Invention

The present invention is generally related to transformers, and more particular to a transformer of enhance common-mode rejection ratio (CMRR).

### (b) Description of the Prior Art

A conventional common-mode filter mainly has a first coil and a second coil wound around an iron core. The ends of the first and second coil are respectively connected to the terminals of the iron core. When noise current such as common-mode current flows through the common-mode filter, magnetic fields of a same direction are produced on the first and second coil, thereby increasing the inductive reactance of the first and second coil. The common-mode filter therefore appears to have a higher common-mode impedance, which attenuates the common-mode current and, as such, filters the common-mode noise.

For example, as taught in Taiwan Patent No. 1713975, a conventional common-mode filter includes a core cylinder, a first coil and a second coil. The core cylinder is sequentially provided with a first winding area, a second winding area and a third winding area. Two ends of the core cylinder are respectively extended with a first flange and a second flange. The first coil is fixedly wound with a first winding portion of m1 turns, a second winding portion of m2 turns and a third winding portion of m3 turns respectively in the first winding area, the second winding area and the third winding area. The second coil is fixedly wound with a fourth winding portion of n1 turns, a fifth winding portion of n2 turns and a sixth winding portion of n3 turns respectively in the first winding area, the second winding area and the third winding area adjacent to the first coil. The sum of the turns m1, m2 and m3 is equal to the sum of the turns n1, n2 and n3. An isolation area is provided between two turns of the fifth winding portion of the second winding area.

However, the conventional common mode filters suffer inferior mode conversion characteristic (known as Ssd/Sds) when converting common-mode signal to differential-mode signal, leading to lower yield.

### SUMMARY OF THE INVENTION

Therefore, the present invention teaches a transformer of enhanced common-mode rejection ratio, includes an iron core and a number of coils. The iron core includes a first flange, a second flange, and a central column having a first side face and a second side face. The coils include a first coil and a second coil wound around the central column for a number of layers along a direction from the first flange towards the second flange. Within a first layer and along the first side face of the central column, there are sequentially arranged at least a first round of the first coil, a second round of the first coil, a first round of the second coil, a third round of the first coil, a second round of the second coil, a first gap, a third round of the second coil, a fourth round of the first coil, and multiple fifth rounds of the first coil. Within the first layer and along the second side face of the central column, there are sequentially arranged multiple sixth rounds of the first coil, a seventh round of the first coil, a fourth round of the second coil, a second gap, a fifth round of the second coil, an eighth round of the first coil, and ninth rounds of the first coil. Within a second layer surrounding the first layer, there are multiple sixth rounds of the second coil.

In some embodiment, the central column has an I-shape or H-shape.

In some embodiment, the first flange, the second flange, and the central column of the iron core are integrally formed.

In some embodiment, a length of the first gap and the second gap is zero or greater than zero.

The present invention improves production yield by reducing mode conversion characteristic (Ssd/Sds) through enhanced common-mode rejection ratio through specific patterns of winding the first and second coils.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a transformer according to a first embodiment of the present invention.

FIG. 2 is a sectional diagram showing the transformer of FIG. 1.

FIG. 3 is a sectional diagram showing a transformer according to a second embodiment of the present invention.

FIG. 4 is a sectional diagram showing a transformer according to a third embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

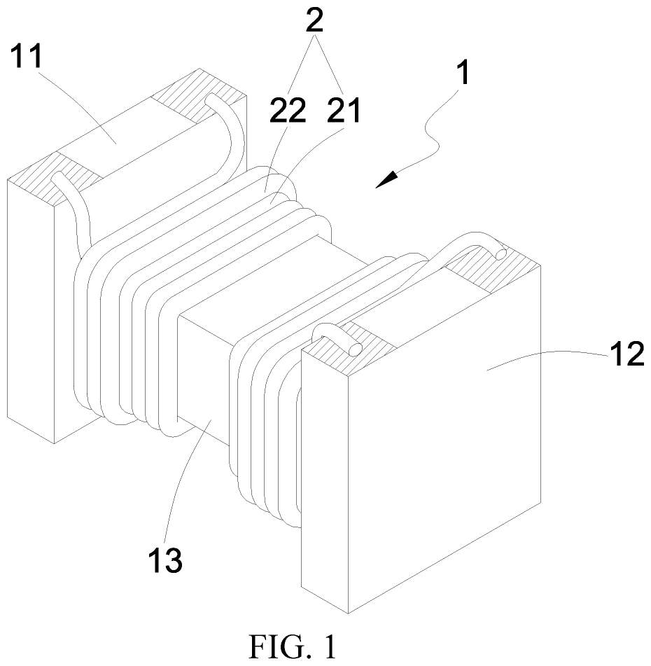

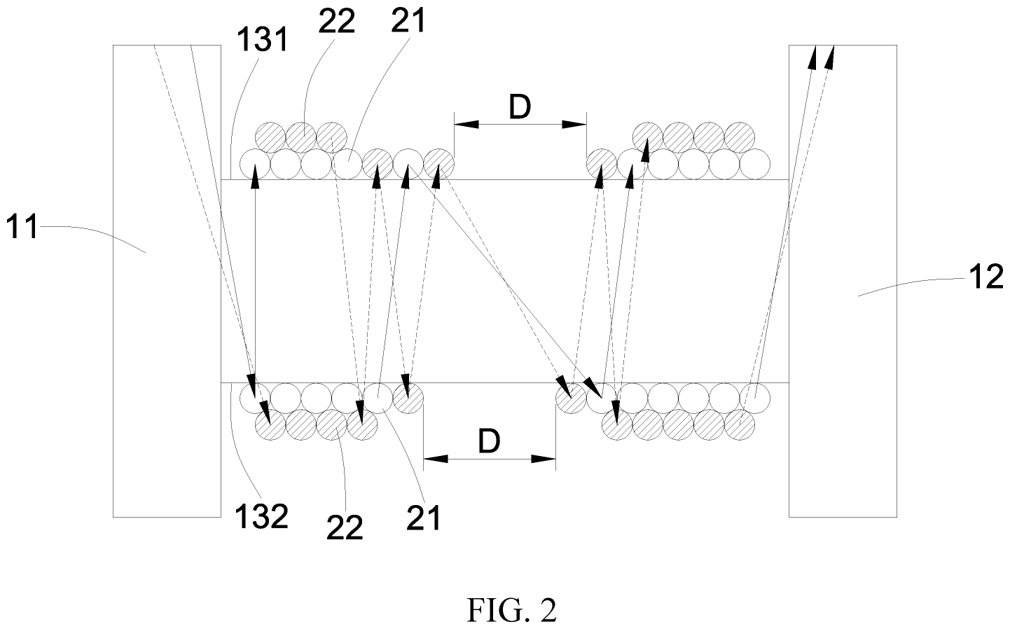

As shown in FIGS. 1 and 2, a transformer according to a first embodiment of the present invention includes an iron core 1 and a number of coils 2.

The iron core 1 includes a first flange 11, a second flange 12, and a central column 13 sandwiched between the first and second flanges 11 and 12. The central column 13 has a first side face 131, and a second side face 132. Specifically, the central column 13 may have an I- or H-shape. The first flange 11, second flange 12, and central column 13 of the iron core 1 may be integrally formed. The iron core 1 may be a Mn—Zn core, a Ni—Zn core, an iron powder core, a molypermalloy powder (MPP) core, a sendust core, or a ferrite core.

The coils 2 includes a first coil 21, and a second coil 22. The coils 2 wind around the central column 13 for a number of layers along a direction from the first flange 11 towards the second flange 12. Within the first layer and along the first side face 131 of the central column 13, there are at least a round of the first coil 21, another round of the first coil 21, a round of the second coil 22, a round of the first coil 21, a round of the second coil 22, a gap D, a round of the second coil 22, a round of the first coil 21, and further a number of rounds of the first coil 21, sequentially arranged in the above-specified order. Within the first layer and along the second side face 132 of the central column 13, there are a number of rounds of the first coil 21, another round of the first coil 21, a round of the second coil 22, a gap D, a round of the second coil 22, a round of the first coil 21, and further a number of rounds of the first coil 21, sequentially arranged in the above-specified order. The second layer surrounds the first layer, and has a number of rounds of the second coil 22. The length of the gap D may be zero or greater than zero.

As shown in FIG. 2, specifically in the present embodiment, within the first layer along the first side face 131 of the central column 13, there are sequentially arranged three rounds of first coil 21, an additional round of the first coil 21, a round of the second coil 22, a further round of the first coil 21, another round of the second coil 22, a gap D, a round of the second coil 22, a round of the first coil 21, and four additional rounds of the first coil 21. Within the first layer along the second side face 132, there are sequentially arranged four rounds of the first coil 21, an additional round of the first coil 21, a round of the second coil 22, a gap D, a round of the second coil 22, a round of the first coil 21, and five more rounds of the first coil 21. Then, within the second layer, there are multiple rounds of the second coil 22.

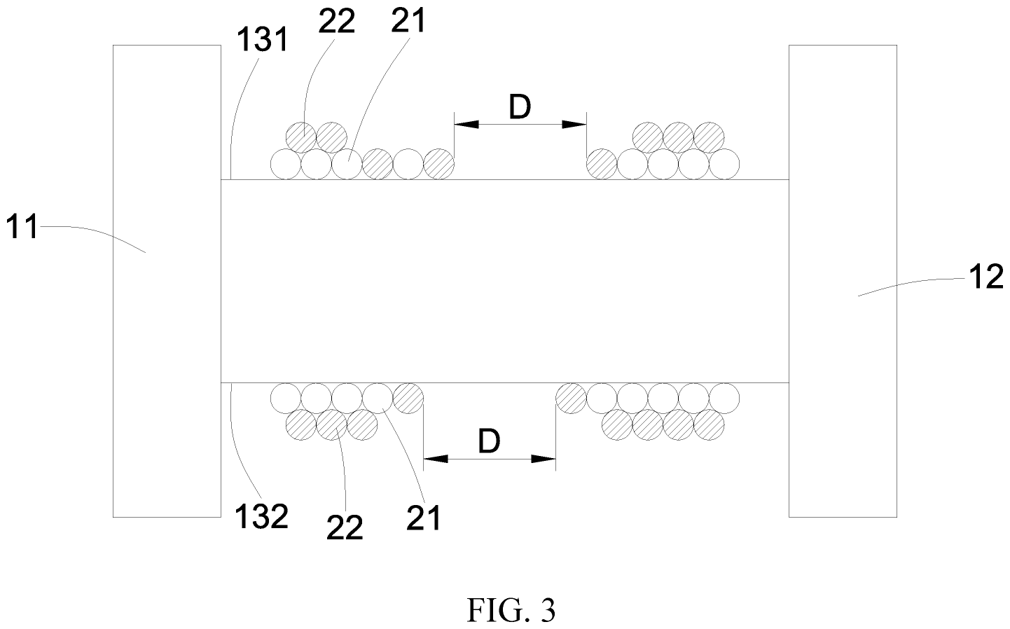

FIG. 3 discloses a second embodiment of the present invention. As illustrated, specifically in the present embodiment, within the first layer along the first side face 131 of the central column 13, there are sequentially arranged two rounds of the first coil 21, an additional round of the first coil 21, a round of the second coil 22, around round of the first coil 21, a round of the second coil 22, a gap D, a round of the second coil 22, a round of the first coil 21, and three rounds of the first coil 21. Within the first layer along the second side face 132 of the central column 13, there are sequentially arranged three rounds of the first coil 21, an additional round of the first coil 21, a round of the second coil 22, a gap D, a round of the second coil 22, a round of the first coil 21, and four more rounds of the first coil 21. Then, within the second layer, there are multiple rounds of the second coil 22.

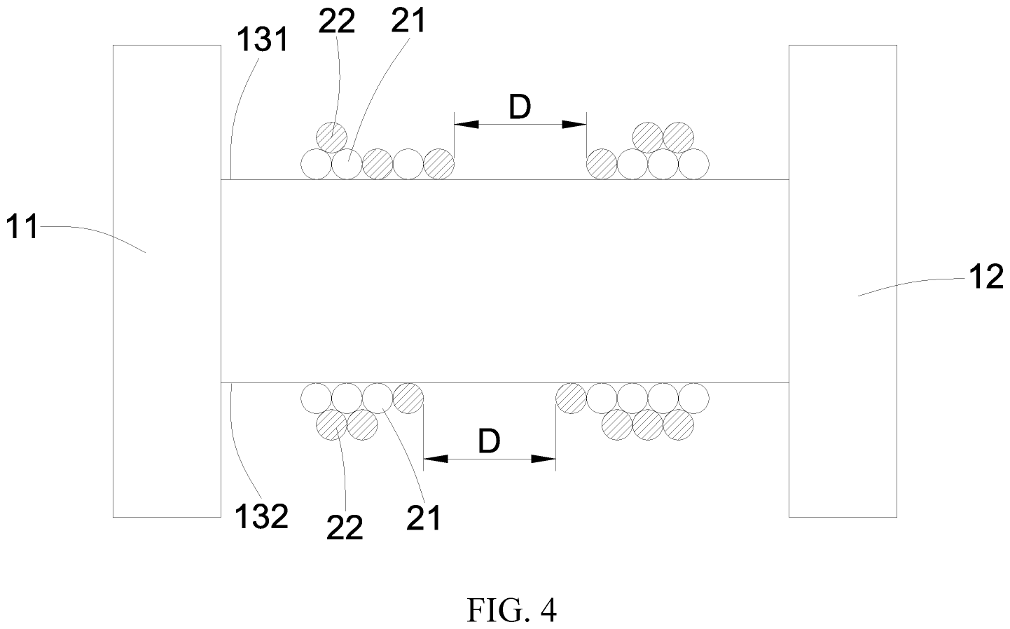

FIG. 4 discloses a third embodiment of the present invention. As illustrated, specifically in the present embodiment, within the first layer along the first side face 131 of the central column 13, there are sequentially arranged a round of the first coil 21, another round of the first coil 21, a round of the second coil 22, an additional round of the first coil 21, a round of the second coil 22, a gap D, a round of the second coil 22, a round of the first coil 21, and two more rounds of the first coil 21. Within the first layer along the second side face 132, there are sequentially arranged two rounds of the first coil 21, an additional rounds of the first coil 21, a round of the second coil 22, a gap D, a round of the second coil 22, a round of the first coil 21, and three more rounds of first coil 21. Then, within the second layer, there are multiple rounds of the second coil 22.

As described above, the present invention improves production yield by reducing mode conversion characteristic (Ssd/Sds) through enhanced common-mode rejection ratio through specific patterns of winding the first and second coils.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A transformer of enhanced common-mode rejection ratio, comprising:
an iron core comprising a first flange, a second flange, and a central column sandwiched between the first and second flanges, where the central column has a first side face and a second side face; and
a plurality of coils comprising a first coil and a second coil wound around the central column for a plurality of layers along a direction from the first flange towards the second flange;
wherein, within a first layer and along the first side face of the central column, there are sequentially arranged at least a first round of the first coil, a second round of the first coil, a first round of the second coil, a third round of the first coil, a second round of the second coil, a first gap, a third round of the second coil, a fourth round of the first coil, and a plurality of fifth rounds of the first coil;
within the first layer and along the second side face of the central column, there are sequentially arranged a plurality of sixth rounds of the first coil, a seventh round of the first coil, a fourth round of the second coil, a second gap, a fifth round of the second coil, an eighth round of the first coil, and a plurality of ninth rounds of the first coil; and
within a second layer surrounding the first layer, there are a plurality of sixth rounds of the second coil.

2. The transformer according to claim 1, wherein the central column has an I-shape or H-shape.

3. The transformer according to claim 1, wherein the first flange, the second flange, and the central column of the iron core are integrally formed.

4. The transformer according to claim 1, wherein a length of the first and the second gap is zero or greater than zero.
